(19) United States
(12) Patent Application Publication
(10) Pub. No.: US 2026/0118508 A1
(43) Pub. Date: Apr. 30, 2026

(54) INFORMATION PROCESSING METHOD, INFORMATION PROCESSING SYSTEM, INFORMATION PROCESSING DEVICE, AND RECORDING MEDIUM

(71) Applicant: Panasonic Intellectual Property Management Co., Ltd., Osaka (JP)

(72) Inventors: Risako TANIGAWA, Kanagawa (JP); Saeko SHINGU, Osaka (JP); Tatsumi NAGASHIMA, Osaka (JP)

(21) Appl. No.: 19/432,443

(22) Filed: Dec. 24, 2025

Related U.S. Application Data
(63) Continuation of application No. PCT/JP2024/008448, filed on Mar. 6, 2024.

(30) Foreign Application Priority Data
Jul. 26, 2023 (JP) 2023-122013

(51) Int. Cl. G01S 15/89; G05B 15/02

(52) U.S. Cl. CPC G01S 15/89; G05B 15/02

(57) ABSTRACT

An information processing method is executed by a computer, and includes: transmitting a sound; obtaining a reflected sound resulting from the sound; determining whether a person detected using the reflected sound is a person not permitted to operate a predetermined device; and controlling the predetermined device based on a result obtained in the determining.

### CROSS REFERENCE TO RELATED APPLICATIONS

This is a continuation application of PCT International Application No. PCT/JP2024/008448 filed on Mar. 6, 2024, designating the United States of America, which is based on and claims priority of Japanese Patent Application No. 2023-122013 filed on Jul. 26, 2023. The entire disclosures of the above-identified applications, including the specifications, drawings and claims are incorporated herein by reference in their entirety.

### FIELD

The present disclosure relates to an information processing method, an information processing system, an information processing device, and a recording medium.

### BACKGROUND

Devices that detect a person using ultrasonic waves are conventionally known. Patent Literature (PTL) 1 discloses a device that detects a person present in a room by emitting an ultrasonic signal and then powers on various devices provided in the room.

### CITATION LIST

### Patent Literature

PTL 1: Specification of U.S. Pat. No. 10,795,018

### SUMMARY

### Technical Problem

However, when the person detected using a sound is a young child, it may be undesirable to power on a device provided in the room. Furthermore, when the young child performs some kind of operation input on the device, this may cause a trouble if the device starts operating in response to the operation input. In view of this, a predetermined device needs to be controlled based on the characteristics of the person detected using the sound.

The present disclosure provides an information processing method and the like that are capable of controlling a predetermined device based on a person detected using a sound.

### Solution to Problem

An information processing method according to an aspect of the present disclosure is executed by a computer and includes: transmitting a sound; obtaining a reflected sound resulting from the sound; determining whether a person detected using the reflected sound is a person not permitted to operate a predetermined device; and controlling the predetermined device based on a result obtained in the determining.

An information processing system according to another aspect of the present disclosure includes: a sound emitter that transmits a sound; a sound receiver that obtains a reflected sound resulting from the sound; a determiner that determines whether a person detected using the reflected sound is a person not permitted to operate a device; and a controller predetermined that controls the predetermined device based on a result obtained by the determiner.

An information processing device according to still another aspect of the present disclosure includes: a determiner that determines whether a person detected using a reflected sound resulting from a transmitted sound is a person not permitted to operate a predetermined device; and a controller that controls the predetermined device based on a result obtained by the determiner.

A non-transitory computer-readable recording medium having recorded thereon a program for causing a computer to execute the information processing method described above.

It should be noted that a general or specific aspect of the present disclosure may be embodied as a system, a method, an integrated circuit, a computer program, or a computer-readable recording medium, such as a CD-ROM, or may be embodied as any combination of the system, method, integrated circuit, computer program, and recording medium.

### Advantageous Effects

The information processing method and the like according to the present disclosure are capable of controlling a predetermined device based on a person detected using a sound.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an information processing system according to Embodiment 1.

FIG. 2 is a block diagram illustrating the functional configuration of the information processing system as well as a detection device and an information processing device included in the information processing system.

FIG. 3 is a diagram illustrating device information and indoor information stored in a storage of the information processing device.

FIG. 4 is a flowchart illustrating an operation for determining whether the detected person is a child.

FIG. 5 is a diagram illustrating an example of control details to be executed based on the person detected using reflected sound.

FIG. 6 is a flowchart illustrating an information processing method according to Embodiment 1.

FIG. 7 is a flowchart illustrating an information processing method according to Variation 1 of Embodiment 1.

FIG. 8 is a flowchart illustrating an information processing method according to Variation 2 of Embodiment 1.

FIG. 9 is a flowchart illustrating an information processing method according to Variation 3 of Embodiment 1.

FIG. 10 is a block diagram illustrating the functional configuration of an information processing system according to Embodiment 2.

FIG. 11 is a block diagram illustrating the functional configuration of an information processing system according to Embodiment 3.

FIG. 12 is a block diagram illustrating the functional configuration of an information processing system according to Embodiment 4.

FIG. 13 is a diagram illustrating device information, indoor information, and family composition information stored in a storage of an information processing device.

FIG. 14 is a flowchart illustrating an information processing method according to Embodiment 4.

### DESCRIPTION OF EMBODIMENTS

Technology for detecting a person present in a room by emitting an ultrasonic signal and then powering on various devices provided in the room is conventionally known. However, when the person detected using the sound is a young child, it may be undesirable to power on a device provided in the room.

Furthermore, when the young child performs some kind of operation input on the device, this may cause a trouble if the device starts operating in response to the operation input. For example, when the young child performs an operation input on an electrical device, such as a heater or a gas appliance, that is provided in a room, this young child or the indoor environment may be placed in a dangerous state. In view of this, it is desirable to detect a person present in a room using a sound, determine the characteristics of the detected person, and control an electrical device in the room based on the detected person.

The information processing method and the like according to the present disclosure have the configuration described below to control a predetermined device based on a person detected using a sound.

An information processing method according to Example 1 is executed by a computer and includes: transmitting a sound; obtaining a reflected sound resulting from the sound; determining whether a person detected using the reflected sound is a person not permitted to operate a predetermined device; and controlling the predetermined device based on a result obtained in the determining.

In this way, the predetermined device can be controlled based on whether the person detected using the reflected sound is the aforementioned not-permitted person.

An information processing method according to Example 2 is the information processing method according to Example 1, wherein in the controlling, when the person detected using the reflected sound is determined to be the person not permitted to operate the predetermined device, the predetermined device is controlled to restrict an external operation performed on the predetermined device.

In this way, for example, even when an operation input is performed on the predetermined device by the aforementioned not-permitted person, the predetermined device is prevented from operating in response to the operation input.

An information processing method according to Example 3 is the information processing method according to Example 1 or Examiner 2, wherein in the controlling, when the person detected using the reflected sound is determined to be a person permitted to operate the predetermined device, the predetermined device is controlled not to restrict an external operation performed on the predetermined device.

In this way, for example, the aforementioned permitted person is able to freely operate the predetermined device.

An information processing method according to Example 4 is the information processing method according to any one of Examples 1 to 3, wherein the predetermined device is an electrical device provided in a space in which the person detected using the reflected sound is present.

In this way, the electrical device provided in the space in which the person detected using the reflected sound is present can be controlled.

An information processing method according to Example 5 is the information processing method according to any one of Examples 1 to 4, wherein in the determining, the person is detected based on an image indicating a direction of arrival of a reflected wave resulting from the reflected sound.

In this way, the person can be accurately detected using the reflected sound, and the predetermined device can be controlled based on the person detected.

An information processing method according to Example 6 is the information processing method according to Example 5, wherein the determining is performed based on a corrected-normalized value, the corrected-normalized value is calculated by correcting and normalizing, using a distance, one of: a size of an area corresponding to the person detected, in the image; or an aspect ratio of the area corresponding to the person detected, when the corrected-normalized value is less than or equal to a predetermined value, the person detected is determined to be the person not permitted to operate the predetermined device, and when the corrected-normalized value exceeds the predetermined value, the person detected is determined to be a person permitted to operate the predetermined device.

In this way, in the determining, the corrected-normalized value is calculated by correcting and normalizing, using the distance, one of: the size of the area corresponding to the person in the image; or the aspect ratio of the area corresponding to the person. Thus, for example, when the person detected is a child and an operation input is performed on the predetermined device by the child, the predetermined device is prevented from operating in response to the operation input.

An information processing method according to Example 7 is the information processing method according to any one of Examples 1 to 6, wherein the sound is an ultrasonic wave.

In this way, the person is accurately detected using the ultrasonic wave, and the predetermined device can be controlled based on the person detected.

An information processing method according to Example 8 is the information processing method according to any one of Examples 1 to 7, further including: when a plurality of persons are detected using the reflected sound and the plurality of persons include both the person not permitted and a person permitted to operate the predetermined device, obtaining, based on the reflected sound, both a position of the person not permitted and a position of the person permitted; and controlling the predetermined device based on a first distance between the person not permitted and the person permitted.

In this way, the predetermined device can be controlled based on the first distance between the plurality of persons detected.

An information processing method according to Example 9 is the information processing method according to Example 8, wherein in the controlling, when the first distance is greater than or equal to a first threshold value, the predetermined device is controlled to restrict an external operation performed on the predetermined device, and when the first distance is less than the first threshold value, the predetermined device is controlled without the restriction of the external operation performed on the predetermined device.

In this way, the predetermined device can be controlled based on whether the first distance is greater than or equal to the first threshold value.

An information processing method according to Example 10 is the information processing method according to any one of Examples 1 to 9, further including: obtaining a position of the person detected, based on the reflected sound; obtaining position information of the predetermined device; and controlling the predetermined device based on a second distance between the person detected and the predetermined device.

In this way, the predetermined device can be controlled based on the second distance between the person detected and the predetermined device.

An information processing method according to Example 11 is the information processing method according to Example 10, wherein in the controlling, when the second distance is less than a second threshold value, the predetermined device is controlled to restrict an external operation performed on the predetermined device, and when the second distance is greater than or equal to the second threshold value, the predetermined device is controlled without the restriction of the external operation performed on the predetermined device.

In this way, the predetermined device can be controlled based on whether the second distance is greater than or equal to the second threshold value.

An information processing method according to Example 12 is the information processing method according to any one of Examples 1 to 7, further including: obtaining registration information when information indicating that the predetermined device has received an external operation input is received as a trigger, the registration information indicating whether the predetermined device that has received the external operation input is a registered device that has been registered in advance to restrict an external operation; and controlling, based on the registration information, the predetermined device that has received the external operation input.

In this way, the predetermined device that has received the operation input can be controlled based on whether the predetermined device is the registered device.

An information processing method according to Example 13 is the information processing method according to Example 12, wherein in the controlling, when the predetermined device that has received the external operation input is the registered device and the person detected using the reflected sound is determined to be the person not permitted to operate the predetermined device, the predetermined device is controlled to be prevented from operating in response to the external operation input.

In this way, the predetermined device can be controlled based on: whether the predetermined device that has received the operation input is the registered device; and whether the person detected using the reflected sound is the aforementioned not-permitted person.

An information processing system according to Example 14 includes: a sound emitter that transmits a sound; a sound receiver that obtains a reflected sound resulting from the sound; a determiner that determines whether a person detected using the reflected sound is a person not permitted to operate a predetermined device; and a controller that controls the predetermined device based on a result obtained by the determiner.

According to the information processing system, the predetermined device can be controlled based on whether the person detected using the reflected sound is the aforementioned not-permitted person. Thus, the predetermined device can be controlled based on the person detected using the reflected sound.

An information processing device according to Example 15 includes: a determiner that determines whether a person detected using a reflected sound resulting from a transmitted sound is a person not permitted to operate a predetermined device; and a controller that controls the predetermined device based on a result obtained by the determiner.

According to the information processing device, the predetermined device can be controlled based on whether the person detected using the reflected sound is the aforementioned not-permitted person. Thus, the predetermined device can be controlled based on the person detected using the reflected sound.

A non-transitory computer-readable recording medium according to Example 16 has recorded thereon a program for causing a computer to execute the information processing method according to any one of Examples 1 to 13.

According to the recording medium, the information processing method capable of controlling the predetermined device based on the detected person can be provided.

An information processing method, an information processing system, an information processing device, and the like according to aspects of the present disclosure are described below in detail with reference to the figures.

It should be noted that the embodiments described below show specific examples of the present disclosure. The numerical values, shapes, materials, structural elements, arrangement and connection of the structural elements, steps, order of the steps, and the like are mere examples and do not intend to limit the present disclosure.

Furthermore, among the structural elements described in the embodiments below, those not recited in the independent claims representing superordinate concepts are described as optional structural elements.

### Embodiment 1

### [Overall Configuration of Information Processing System]

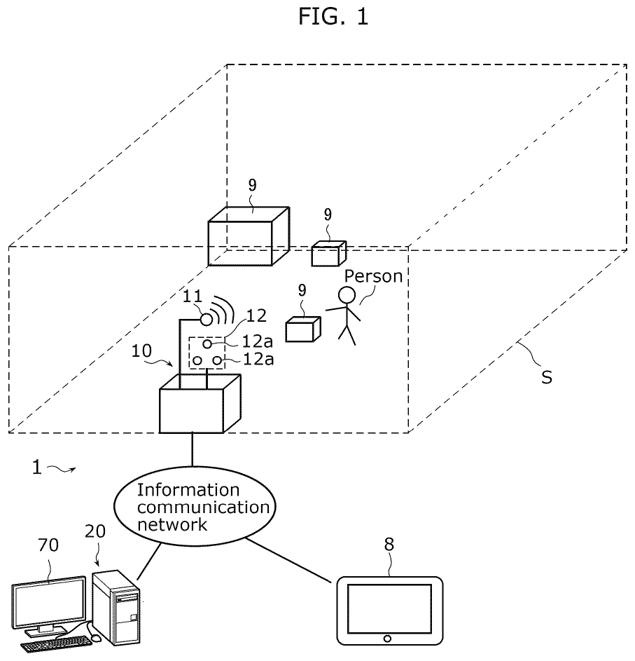

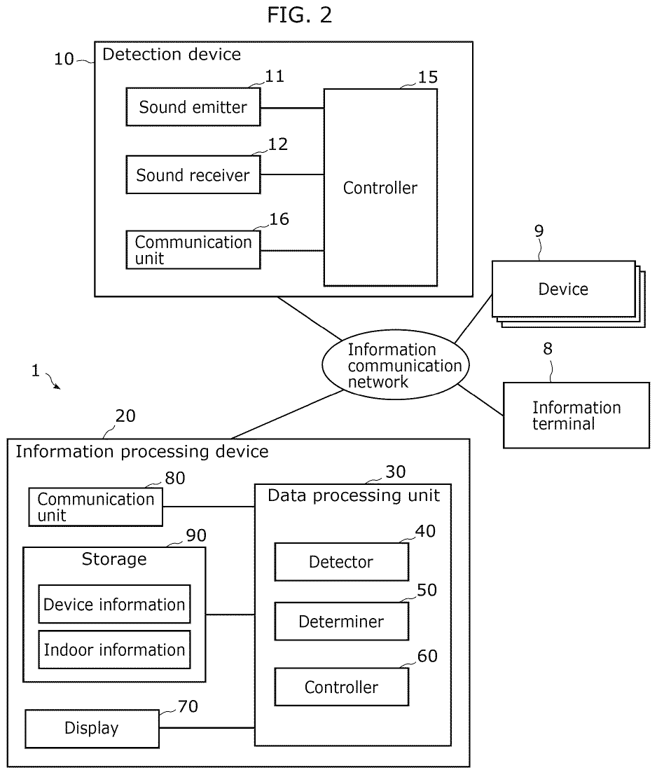

The overall configuration of an information processing system according to Embodiment 1 is described with reference to FIGS. 1 and 2.

The information processing system according to Embodiment 1 is a system that controls devices provided in a space used by persons. The space referred to here is, for example, an indoor space of a facility, such as a house or an apartment building. The space may also be an indoor space of a facility, such as an art gallery, a museum, a department store, or an event venue.

FIG. 1 is a diagram illustrating information processing system 1 according to Embodiment 1. FIG. 2 is a block diagram illustrating the functional configuration of information processing system 1 as well as detection device 10 and information processing device 20 included in information processing system 1. Note that FIGS. 1 and 2 also show a plurality of devices 9 provided in indoor space S and information terminal 8 carried by a user inside or outside indoor space S.

As illustrated in FIGS. 1 and 2, information processing system 1 includes detection device 10 and information processing device 20. Detection device 10 is a device that detects a person present in indoor space S. For example, detection device 10 is mounted on a wall of indoor space S. Detection device 10 is communicatively connected to information processing device 20 via an information communication network. Detection device 10 transmits, to information processing device 20, detection information obtained by detection device 10.

Information processing device 20 is a device that controls predetermined device 9 provided in indoor space S, based on the detection information transmitted from detection device 10. Information processing device 20 is located outside indoor space S and provided in, for example, a building of a service operating company that offers device control services. Information processing device 20 is communicatively connected to detection device 10, the plurality of devices 9, and information terminal 8 via the information communication network.

Information terminal 8 is communicatively connected to information processing device 20 via the information communication network. Information terminal 8 is a terminal device used by the user who uses indoor space S and the plurality of devices 9. Information terminal 8 is a smartphone or a tablet terminal, for example. Information terminal 8 displays various kinds of information transmitted from information processing device 20. Moreover, information terminal 8 transmits, to information processing device 20, information inputted to information terminal 8 by the user.

The plurality of devices 9 are communicatively connected to information processing device 20 via the information communication network. The plurality of devices 9 are provided in indoor space S. For example, the plurality of devices 9 include a heater, a gas appliance, and a security device. The plurality of devices 9 may include a heating cooking appliance, a water heater, and a clothes iron. Each of the plurality of devices 9 is capable of transmitting information regarding device 9 itself to information processing device 20. Furthermore, the plurality of devices 9 are operable in response to a control instruction transmitted from information processing device 20.

Sometimes, only a child may be in indoor space S. When the child is in the vicinity of device 9, the child should be prevented from entering a dangerous state. In view of this, information processing system 1 according to the present embodiment causes detection device 10 to detect a person present in indoor space S and controls predetermined device 9 based on the characteristics of the detected person. The following describes the configuration of each of detection device 10 and information processing device 20.

### [Configuration of Detection Device]

Detection device 10 illustrated in FIG. 2 includes sound emitter 11, sound receiver 12, controller 15, and communication unit 16.

Communication unit 16 is a communication module that is communicatively connected to information processing device 20 via the information communication network. Communication unit 16 is connected to the information communication network wirelessly or via a wire.

Sound emitter 11 is an ultrasonic transmitter that transmits a transmission sound in an ultrasonic frequency range. For example, in response to an instruction from controller 15, sound emitter 11 outputs a chirp-wave transmission sound having a frequency of at least 20 kHz and at most 100 kHz. Note that the signal waveform of a sound transmitted from sound emitter 11 may be a burst waveform.

Sound emitter 11 is mounted on a wall of indoor space S, for example, and transmits an ultrasonic wave across the whole of indoor space S. When information processing system 1 is in a setting mode to detect a person, sound emitter 11 continuously transmits ultrasonic waves. The transmission sound transmitted from sound emitter 11 is reflected from a person present in indoor space S.

Sound receiver 12 is a receiver that picks up a sound reflected from the person. Sound receiver 12 is mounted on the wall of indoor space S on which sound emitter 11 is mounted. For example, sound receiver 12 is a microphone array including three or more micro electro mechanical systems (MEMS) microphones 12a. When the number of microphones 12a included in sound receiver 12 is three, three microphones 12a are disposed at the respective vertices of a triangle. To readily detect reflected sounds in a vertical direction and a horizontal direction in indoor space S, four or more microphones may be arranged in the vertical direction, and four or more other microphones may be arranged in the horizontal direction. By receiving the reflected sound, sound receiver 12 generates a reflected wave signal and outputs the reflected wave signal to controller 15.

Controller 15 is a processor that controls sound emitter 11, sound receiver 12, and communication unit 16. Controller 15 outputs information regarding a transmission signal for transmitting a transmission sound and information regarding a reflected wave signal resulting from a reflected sound, to information processing device 20 via communication unit 16.

Detection device 10 according to the present embodiment performs sensing using ultrasonic waves to detect the position of a person. However, in contrast to a camera, detection device 10 is unable to detect, for example, the face of the person. This enables sensing in consideration of privacy. Furthermore, detection device 10 performs active sensing by using a reflected sound resulting from transmission of an ultrasonic wave. Thus, even when the person is not emitting a sound, the person can be detected.

### [Configuration of Information Processing Device]

The configuration of information processing device 20 is described with reference to FIGS. 2 to 5.

Information processing device 20 illustrated in FIG. 2 includes data processing unit 30, display 70, communication unit 80, and storage 90.

Display 70 is a monitor that displays various kinds of information processed by data processing unit 30. For example, display 70 displays an image generated by detector 40 described later, in which, for instance, the face of a person is made unrecognizable in consideration of privacy.

Communication unit 80 is a communication module, and connected to detection device 10, the plurality of devices 9, and information terminal 8 via the information communication network. Communication unit 80 outputs, to data processing unit 30, the detection information transmitted from detection device 10, and transmits information generated by data processing unit 30 to predetermined device 9 and information terminal 8. Furthermore, communication unit 80 outputs, to data processing unit 30, device information transmitted from the plurality of devices 9 and indoor information transmitted from information terminal 8.

Storage 90 stores the device information outputted from the plurality of devices 9 and the indoor information outputted from information terminal 8.

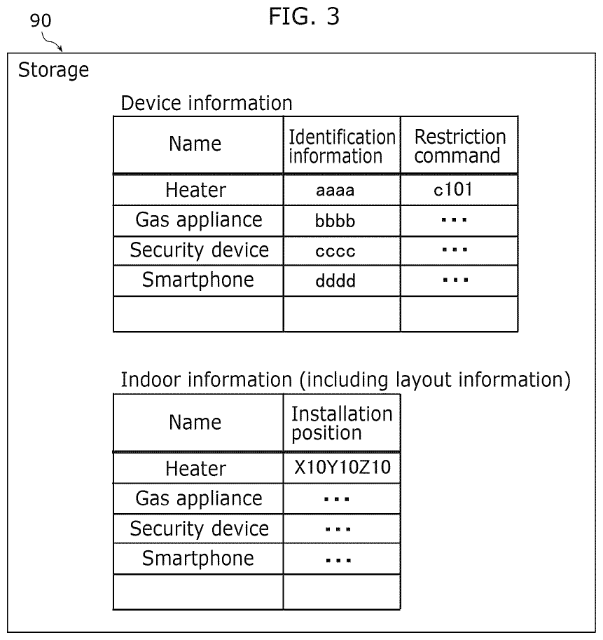

FIG. 3 is a diagram illustrating the device information and the indoor information that are stored in storage 90 of information processing device 20.

The device information stored in storage 90 includes, for example: a name of device 9; identification information (such as an IP address) of device 9; and a restriction command for restricting operation of device 9.

The restriction command is a command that inhibits device 9 from accepting an external operation input. Not accepting an external operation input refers to not accepting an input from an operation switch or the like that is a user interface of device 9, or to ignoring such an input. The restriction command may be a command that inhibits device 9 from being powered on. The restriction command is set for: a device, such as a heater or a gas appliance, that may be placed in a dangerous state when operated by a child; and a device, such as a security device, that should not be easily operated by a child. Such device information is stored in a memory of corresponding device 9. The device information is transmitted from device 9 to information processing device 20 via the information communication network when device 9 is registered by the user.

Then, the device information is stored into storage 90.

The indoor information stored in storage 90 is information regarding, for example, an installation position of device 9 in indoor space S. The indoor information may also include layout information of indoor space S, such as a floor plan of the room. Such indoor information is input to information terminal 8 by the user in association with the device information. Then, the indoor information is transmitted from information terminal 8 to information processing device 20 via the information communication network, and stored into storage 90.

Furthermore, storage 90 stores programs for data processing performed by data processing unit 30. Data processing unit 30 is implemented by a computer that includes a processor.

Data processing unit 30 illustrated in FIG. 2 includes detector 40, determiner 50, and controller 60. Detector 40, determiner 50, and controller 60 are software functions implemented by the processor executing programs stored in storage 90, for example.

Detector 40 detects a person based on the detection information outputted from detection device 10. Detector 40 generates an image indicating a direction of arrival of reflected waves, by performing beamforming on a reflected wave signal obtained via the plurality of microphones 12a. More specifically, detector 40 generates a two-dimensional image by performing beamforming on the reflected wave signal obtained by detection device 10. Beamforming is performed by applying respective specific delays to the plurality of microphones 12a and summing the resulting signals, for each set of position coordinates in the image, along a corresponding direction. The horizontal axis of the generated image corresponds to coordinates in the horizontal direction of indoor space S. The vertical axis of the generated image corresponds to coordinates in the vertical direction of indoor space S. The image shows the intensity distribution of the reflected waves in a plurality of colors or shades.

Detector 40 obtains information regarding the position and size of a person present in indoor space S, from the intensity distribution of the reflected waves shown in the image. For example, when the image includes an area having an intensity value that is greater than or equal to a predetermined value, detector 40 determines that the area corresponds to a person and thus detects the person. More specifically, detector 40 detects the position and size of a person present in indoor space S, based on a high-intensity image area having an intensity value that is greater than or equal to the predetermined value. Detector 40 outputs the obtained detection result to determiner 50.

Determiner 50 determines, based on the detection result obtained by detector 40, whether the detected person is a person not permitted to operate predetermined device 9. Here, determining whether the detected person is a person not permitted to operate predetermined device 9 is based on whether the detected person belongs to a group that satisfies a predetermined condition. For example, when the detected person is a child, determiner 50 determines that the detected person is a person not permitted to operate predetermined device 9. When the detected person is not a child, determiner 50 determines that the detected person is a person permitted to operate predetermined device 9.

For specifically performing the aforementioned determination, determiner 50 identifies whether the detected person is a child, based on the size of the high-intensity image area having an intensity value that is greater than or equal to the predetermined value.

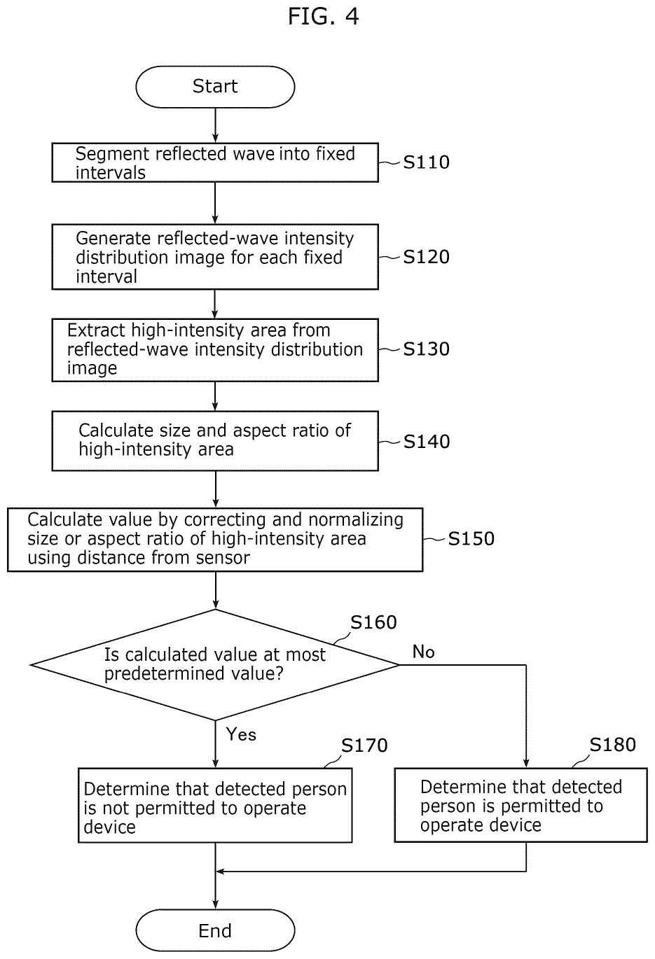

FIG. 4 is a flowchart illustrating an operation for determining whether the detected person is a child.

First, the reflected wave for analysis is segmented into fixed intervals based on the distance from a sensor (sound receiver 12) (step S110). Next, a reflected-wave intensity distribution image is generated for each of the fixed intervals (step S120). Then, a high-intensity area is extracted from the reflected-wave intensity distribution image (step S130). This high-intensity area corresponds to a person. Next, the size and aspect ratio of the high-intensity area are calculated (step S140). Then, a corrected-normalized value is calculated by correcting and normalizing the size or aspect ratio of the high-intensity area using the distance from the sensor (step S150). For example, the corrected-normalized value is calculated by normalizing the aspect ratio using the distance, and then, whether this calculated value is less than or equal to a predetermined value is determined (step S160). When the calculated value is less than or equal to the predetermined value (Yes in S160), the detected person is determined to be a person not permitted to operate device 9 (step S170). In other words, the detected person is determined to be a child in this case. When the calculated value exceeds the predetermined value (No in S160), the detected person is determined to be a person permitted to operate device 9 (step S180). In other words, the detected person is determined to be an adult in this case. Note that determiner 50 may derive the height of the person from the high-intensity image area, and may identify that the detected person is a child when the derived height of the person does not exceed the average height of lower-grade elementary school students (i.e., 7-year-olds). Determiner 50 may derive not only the height of the person, but also, for example, the head size, arm length, leg length, and torso length of the person from the high-intensity image area. Then, based on the derived result, determiner 50 may identify whether the detected person is a child.

The result of the determination performed by determiner 50, or more specifically, the determination result indicating whether the detected person is a person not permitted to operate predetermined device 9 is outputted to controller 60.

Controller 60 controls predetermined device 9 provided in indoor space S, based on the determination result obtained by determiner 50.

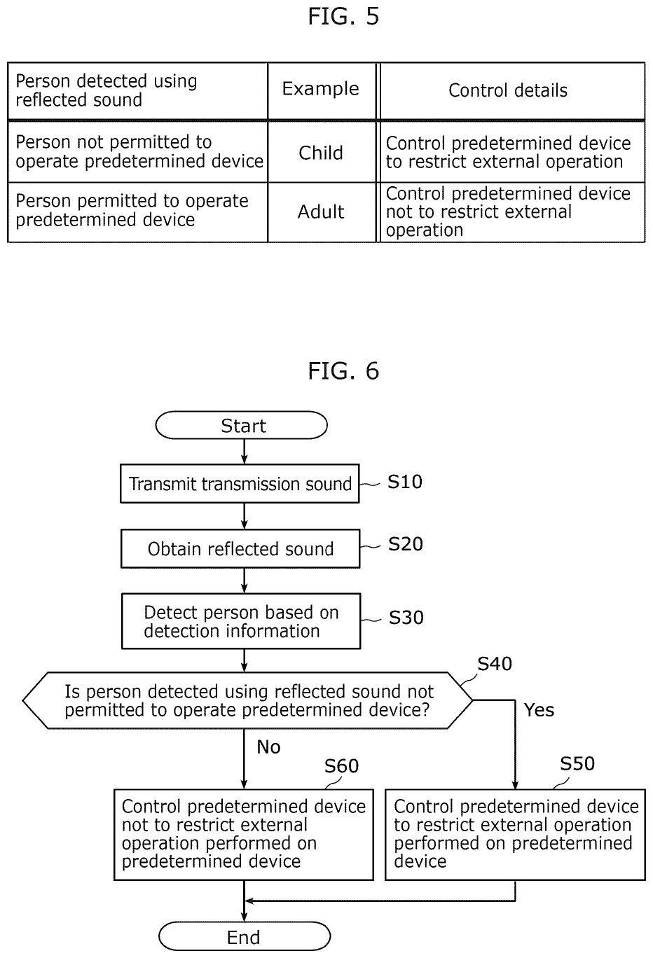

FIG. 5 is a diagram illustrating an example of control details to be executed based on the person detected using the reflected sound.

This diagram illustrates: an example in which the person not permitted to operate predetermined device 9 is a child; and an example in which the person permitted to operate predetermined device 9 is an adult.

As illustrated in FIG. 5, when the detected person is determined to be a person not permitted to operate predetermined device 9, controller 60 controls predetermined device 9 to restrict an external operation performed on predetermined device 9. In contrast, when the detected person is determined to be a person permitted to operate predetermined device 9, controller 60 controls predetermined device 9 not to restrict an external operation performed on predetermined device 9.

Note that restricting an external operation performed on predetermined device 9 means that an operation input performed on device 9 by the aforementioned not-permitted person is not accepted or is ignored. For example, even when an operation input for powering on device 9 that is currently off is received, device 9 is prevented from being powered on. Furthermore, even when an operation input is received from an operation switch or the like of device 9 that is currently on, device 9 is prevented from performing an operation corresponding to the operation input.

As described above, information processing device 20 according to the present embodiment includes: determiner 50 that determines whether the person detected using the reflected sound resulting from the transmission sound is a person not permitted to operate predetermined device 9; and controller 60 that controls predetermined device 9 based on a result obtained by determiner 50.

Information processing device 20 described above is capable of controlling predetermined device 9 based on the person detected using a sound. To be more specific, by determining whether the person detected using the sound is a person not permitted to operate predetermined device 9, a person who should not be permitted to operate device 9, such as a child, is restricted from operating device 9.

### [Information Processing Method]

An information processing method according to Embodiment 1 is described with reference to FIG. 6.

FIG. 6 is a flowchart illustrating the information processing method according to Embodiment 1.

In this information processing method, detection device 10 first transmits a transmission sound toward indoor space S (step S10). Furthermore, detection device 10 obtains a sound reflected from a person as a result of the transmission of the ultrasonic wave (step S20). Detection device 10 outputs the obtained detection information to information processing device 20.

Information processing device 20 detects the person, based on the detection information outputted from detection device 10 (step S30). For example, information processing device 20 generates, based on the reflected sound, an image indicating a direction of arrival of the reflected waves. To be more specific, information processing device 20 generates the image indicating the direction of arrival of the reflected waves by performing beamforming on the reflected wave signal obtained via the plurality of microphones 12a. Then, information processing device 20 obtains information regarding the position and size of the person present in indoor space S, from the intensity distribution of the reflected waves shown in the generated image.

Next, information processing device 20 determines whether the person detected using the reflected sound is a person not permitted to operate predetermined device 9 (step S40).

Information processing device 20 determines whether the detected person is a child, based on the information regarding the size of the person that is obtained in step S30. Note that determining whether the person is a child is substantially equivalent to determining whether the person is an adult. When the detected person is a child, the detected person is determined to be a person not permitted to operate predetermined device 9. When the detected person is not a child, the detected person is determined to be a person permitted to operate predetermined device 9.

Information processing device 20 controls predetermined device 9, based on the result of the determination performed in step S40. Note that predetermined device 9 is an electrical device provided in indoor space S in which the person detected using the reflected sound is present. Information regarding predetermined device 9 has been stored in storage 90 in advance.

When the person detected using the reflected sound is the aforementioned not-permitted person (Yes in S40), information processing device 20 controls predetermined device 9 to restrict an external operation performed on predetermined device 9 (step S50). In contrast, when the person detected using the reflected sound is the aforementioned permitted person (No in S40), information processing device 20 controls predetermined device 9 not to restrict an external operation performed on predetermined device 9 (step S60).

Note that controlling predetermined device 9 not to restrict an operation in step S60 includes allowing predetermined device 9 to perform its own operation without control by information processing device 20. Note also that controlling predetermined device 9 not to restrict an operation includes causing predetermined device 9, upon receiving an external operation input, to perform an operation corresponding to the operation input.

The information processing method described above enables predetermined device 9 to be controlled based on a person detected using a sound. More specifically, when the person detected using the sound is determined to be a person who should not be permitted to operate device 9, such as a child, operation of device 9 is restricted.

### Variation 1

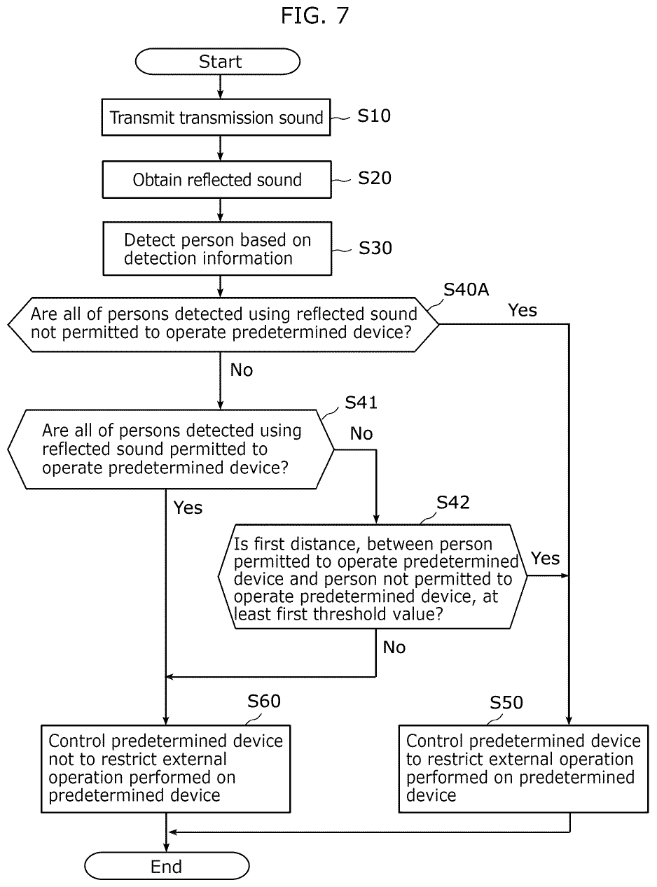

An information processing method according to Variation 1 of Embodiment 1 is described with reference to FIG. 7. In Variation 1, an example is described in which, when a plurality of persons are detected using a sound, predetermined device 9 is controlled based on a distance between the plurality of persons.

FIG. 7 is a flowchart illustrating the information processing method according to Variation 1 of Embodiment 1.

Detection device 10 first transmits a transmission sound toward indoor space S (step S10). Furthermore, detection device 10 obtains a sound reflected from a person as a result of the transmission of the ultrasonic wave (step S20). Detection device 10 outputs the obtained detection information to information processing device 20.

Information processing device 20 detects the person, based on the detection information outputted from detection device 10 (step S30). For example, information processing device 20 generates, based on the reflected sound, an image indicating a direction of arrival of the reflected waves.

In this example, a plurality of persons are present in indoor space S and thus information processing device 20 detects the plurality of persons. Information processing device 20 obtains information regarding the position and size of each of the plurality of persons present in indoor space S, from the intensity distribution of reflected waves shown in an image indicating a direction of arrival of the reflected waves.

Next, information processing device 20 determines whether all of the plurality of persons detected using the reflected sound are persons not permitted to operate predetermined device 9 (step S40A). When all of the plurality of persons detected are determined to be the aforementioned not-permitted persons (Yes in S40A), information processing device 20 controls predetermined device 9 to restrict an external operation performed on predetermined device 9 (step S50). Note that when all of the plurality of persons detected are determined to be the aforementioned not-permitted persons, this means that, for example, all of the plurality of persons detected are children.

When not all of the plurality of persons detected are the aforementioned not-permitted persons (No in S40A), information processing device 20 performs a determination as follows.

In this determination, information processing device 20 determines whether all of the plurality of persons detected are persons permitted to operate predetermined device 9 (step S41).

When all of the plurality of persons detected are determined to be the aforementioned permitted persons (Yes in S41), information processing device 20 controls predetermined device 9 not to restrict an external operation performed on predetermined device 9 (step S60). Note that when all of the plurality of persons detected are determined to be the aforementioned permitted persons, this means that all of the plurality of persons detected are adults.

When not all of the plurality of persons detected are determined to be the aforementioned permitted persons (No in S41), information processing device 20 performs a determination as follows. Note that when not all of the plurality of persons detected are determined to be the aforementioned permitted persons in step S41, this means that at least one of the plurality of persons detected is not permitted and the remainder of the plurality of persons detected are permitted. This applies to a case in which the plurality of persons detected includes a child and an adult, for example.

In the determination, information processing device 20 determines whether a first distance between the person not permitted to operate predetermined device 9 and the person permitted to operate predetermined device 9 is greater than or equal to a first threshold value (step S42). In other words, information processing device 20 determines whether the child is away from the adult in indoor space S. Note that the first distance is calculated based on the image generated in step S30 that indicates the direction of arrival of the reflected waves. The first threshold value is a predetermined value and set to a distance reachable by an adult (for example, 1 meter or less).

When the first distance between the person not permitted to operate predetermined device 9 and the person permitted to operate predetermined device 9 is greater than or equal to the first threshold value (Yes in S42), information processing device 20 controls predetermined device 9 to restrict an external operation performed on predetermined device 9 (step S50). More specifically, when the child and the adult are too far apart in indoor space S, the adult is unable to keep the child from performing an action. For this reason, an external operation performed on predetermined device 9 is restricted.

In contrast, when the first distance between the person not permitted to operate predetermined device 9 and the person permitted to operate predetermined device 9 is less than the first threshold value (No in S42), information processing device 20 controls predetermined device 9 not to restrict an external operation performed on predetermined device 9 (step S60). More specifically, when the distance between the child and the adult is small in indoor space S, the adult is able to keep the child from performing an action. For this reason, an external operation performed on predetermined device 9 is not restricted.

The information processing method according to Variation 1 enables predetermined device 9 to be controlled based on the first distance between the plurality of persons detected. More specifically, when one of the plurality of persons detected is determined to be a person who should not be permitted to operate device 9, such as a child, operation of device 9 is restricted.

In the example described above, the procedure of steps S10 through S60 is executed once. However, in practice, this procedure is executed repeatedly. Thus, even while an external operation on predetermined device 9 is restricted, this restriction is lifted when the first distance falls below the first threshold value. Moreover, even while an external operation on predetermined device 9 is not restricted, the operation is restricted when the first distance becomes greater than or equal to the first threshold value. Note that the restriction may be lifted after the first distance has remained below the first threshold value for a predetermined period of time (for example, 10 seconds).

### Variation 2

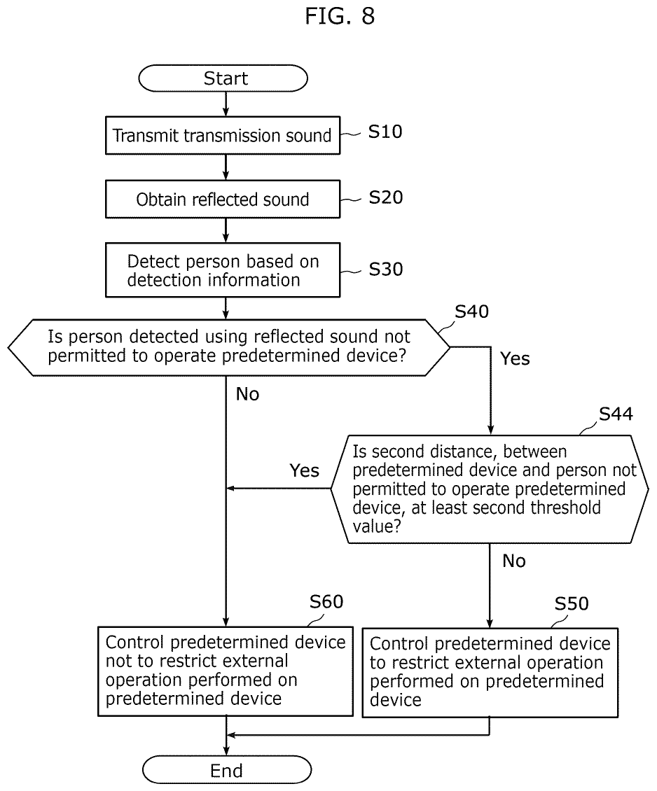

An information processing method according to Variation 2 of Embodiment 1 is described with reference to FIG. 8. In Variation 2, an example is described in which predetermined device 9 is controlled based on a distance between a person detected using a sound and predetermined device 9.

FIG. 8 is a flowchart illustrating the information processing method according to Variation 2 of Embodiment 1.

Detection device 10 first transmits a transmission sound toward indoor space S (step S10). Furthermore, detection device 10 obtains a sound reflected from a person as a result of the transmission of the ultrasonic wave (step S20). Detection device 10 outputs the obtained detection information to information processing device 20.

Information processing device 20 detects the person, based on the detection information outputted from detection device 10 (step S30).

Next, information processing device 20 determines whether the person detected using the reflected sound is a person not permitted to operate predetermined device 9 (step S40).

When the detected person is determined to be a person permitted to operate predetermined device 9 (No in S40), information processing device 20 controls predetermined device 9 not to restrict an external operation performed on predetermined device 9 (step S60).

When the detected person is determined to be a person not permitted to operate predetermined device 9 (Yes in S40), information processing device 20 performs a determination as follows. In the determination, information processing device 20 determines whether a second distance between predetermined device 9 and the person not permitted to operate predetermined device 9 is greater than or equal to a second threshold value (step S44). In other words, information processing device 20 determines whether the child is away from predetermined device 9 in indoor space S. Note that the second distance is calculated based on: the image generated in step S30 that indicates the direction of arrival of the reflected waves; and information regarding the installation position of predetermined device 9 stored in storage 90. The second threshold value is a predetermined value and set to at least the height of a child (for example, 1 meter or more).

When the second distance between predetermined device 9 and the person not permitted to operate predetermined device 9 is less than the second threshold value (No in S44), information processing device 20 controls predetermined device 9 to restrict an external operation performed on predetermined device 9 (step S50). More specifically, when the distance between the child and predetermined device 9 is too small in indoor space S, the child can easily touch device 9. For this reason, an external operation performed on predetermined device 9 is restricted.

In contrast, when the second distance between predetermined device 9 and the person not permitted to operate predetermined device 9 is greater than or equal to the second threshold value (Yes in S44), information processing device 20 controls predetermined device 9 not to restrict an external operation performed on predetermined device 9 (step S60). More specifically, when the distance between the child and predetermined device 9 is large in indoor space S, the child cannot easily touch device 9. For this reason, an external operation performed on predetermined device 9 is not restricted.

The information processing method according to Variation 2 enables predetermined device 9 to be controlled based on the second distance between the detected person and predetermined device 9. More specifically, when the detected person is determined to be a person who should not be permitted to operate device 9, such as a child, operation of device 9 in the vicinity of the child is restricted.

In the example described above, the procedure of steps S10 through S60 is executed once. However, in practice, this procedure is executed repeatedly. Thus, even while an external operation on predetermined device 9 is restricted, this restriction is lifted when the second distance becomes greater than or equal to the second threshold value. Moreover, even while an external operation on predetermined device 9 is not restricted, the operation is restricted when the second distance falls below the second threshold value. Note that the restriction may be lifted after the second distance has remained at or above the second threshold value for a predetermined period of time (for example, 10 seconds).

### Variation 3

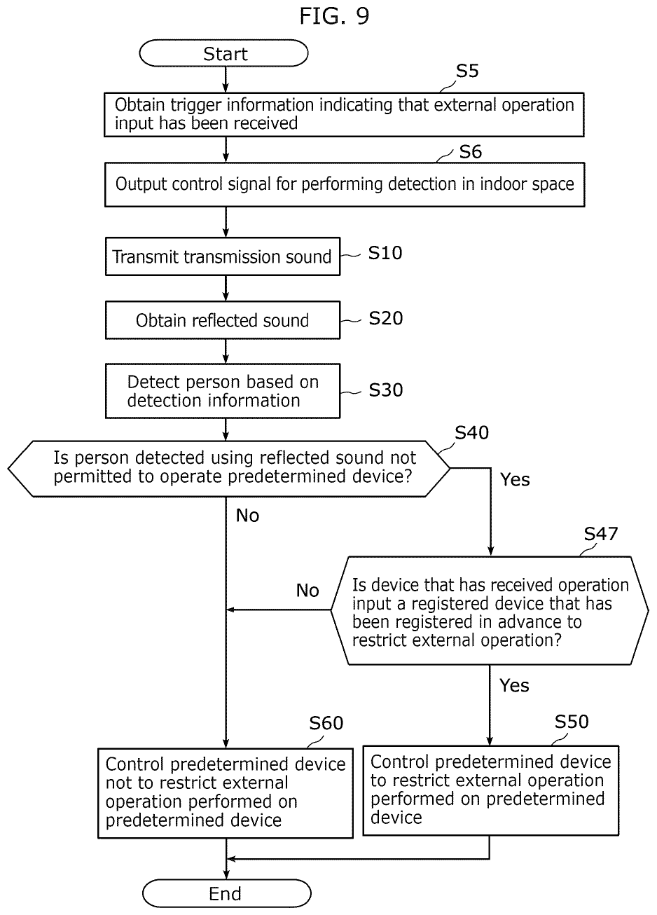

An information processing method according to Variation 3 of Embodiment 1 is described with reference to FIG. 9. In Variation 3, an example is described in which, when device 9 has received an external operation input, control triggered by this operation input is performed on device 9 that has received the operation input.

FIG. 9 is a flowchart illustrating the information processing method according to Variation 3 of Embodiment 1.

When device 9 provided in indoor space S has received some kind of operation input from a person present in indoor space S, device 9 outputs information indicating that an external operation input has been received, to information processing device 20 via the information communication network. Note that the detection function of detection device 10 is not activated at this moment and thus trigger information indicating that the external operation input has been received is outputted from device 9.

Information processing device 20 obtains the trigger information indicating that the external operation input has been performed (step S5). For example, when device 9 is a heater, information indicating that the heater has been powered on serves as the trigger information described above. For example, when device 9 is a smartphone, authentication information for smartphone billing serves as the trigger information described above.

When information processing device 20 has obtained the trigger information, information processing device 20 outputs a control signal to detection device 10, thereby causing detection device 10 to perform detection in indoor space S (step S6).

When detection device 10 has received the control signal, detection device 10 transmits a transmission sound (step S10). Furthermore, detection device 10 obtains a reflected sound resulting from the transmission of the ultrasonic wave (step S20). Note that detection device 10 may execute steps S10 and S20 by obtaining, via the information communication network, the trigger information outputted from device 9.

Next, information processing device 20 detects the person, based on the detection information outputted from detection device 10 (step S30).

Next, information processing device 20 determines whether the person detected using the reflected sound is a person not permitted to operate predetermined device 9 (step S40).

When the detected person is determined to be a person permitted to operate predetermined device 9 (No in S40), information processing device 20 controls predetermined device 9 not to restrict an external operation performed on predetermined device 9 (step S60).

When the detected person is the aforementioned not-permitted person (Yes in S40), information processing device 20 performs a determination as follows.

In the determination, information processing device 20 determines whether device 9 that has received the operation input is a registered device that has been registered to restrict an external operation (step S47). More specifically, information processing device 20 determines whether device 9 that has received the operation input is a device that may enter an undesirable state due to the operation input. Note that registration information indicating whether the device is a registered device that has been registered in advance to restrict an external operation has been stored in storage 90 by information terminal 8 in advance.

When device 9 is not a registered device, or more specifically, when the registration information is not stored in storage 90 (No in S47), information processing device 20 controls predetermined device 9 not to restrict an external operation performed on predetermined device 9 (step S60).

When device 9 is a registered device, or more specifically, when the registration information is stored in storage 90 (Yes in S47), information processing device 20 controls predetermined device 9 to restrict an external operation performed on predetermined device 9 (step S50). For example, information processing device 20 controls predetermined device 9 to prevent predetermined device 9 from operating in response to the external operation input. In this case, information processing device 20 may output, to information terminal 8 via the information communication network, information indicating that an external operation on predetermined device 9 has been attempted and then restricted.

The information processing method according to Variation 3 enables predetermined device 9 to be controlled based on a relationship between the detected person and predetermined device 9 that has received an operation input. More specifically, when the person detected using a sound is determined to be a person who should not be permitted to operate device 9, such as a child, device 9 that has received the operation input is prevented from operating.

### Embodiment 2

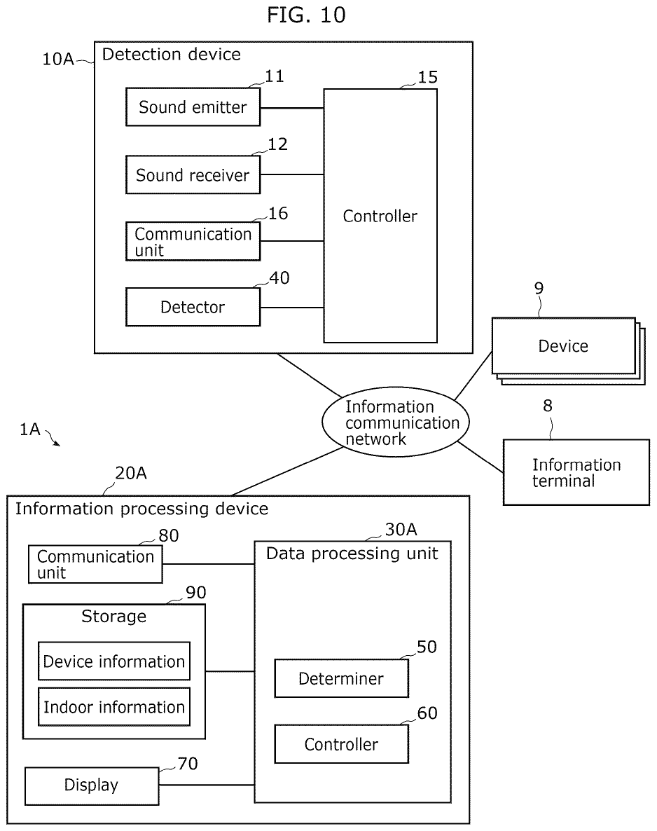

Information processing system 1A according to Embodiment 2 is described with reference to FIG. 10. In Embodiment 2, an example is described in which detection device 10A has the functions of detector 40.

FIG. 10 is a block diagram illustrating the functional configuration of information processing system 1A according to Embodiment 2. Note that FIG. 10 also shows a plurality of devices 9 and information terminal 8.

As illustrated in FIG. 10, information processing system 1A includes detection device 10A and information processing device 20A.

Detection device 10A is a device that detects a person present in indoor space S. Detection device 10A is communicatively connected to information processing device 20A via an information communication network. Detection device 10A transmits, to information processing device 20A, information obtained by detection device 10A.

Information processing device 20A is a device that controls predetermined device 9 provided in indoor space S, based on the information transmitted from detection device 10A. Information processing device 20A is communicatively connected to detection device 10A, the plurality of devices 9, and information terminal 8 via the information communication network.

Information terminal 8 is communicatively connected to information processing device 20A via the information communication network. Information terminal 8 displays various kinds of information transmitted from information processing device 20A. Moreover, information terminal 8 transmits, to information processing device 20A, information inputted to information terminal 8.

The plurality of devices 9 are communicatively connected to information processing device 20A via the information communication network. Each of the plurality of devices 9 is capable of transmitting information regarding device 9 itself to information processing device 20A. Furthermore, the plurality of devices 9 are operable in response to a control instruction transmitted from information processing device 20A.

Detection device 10A illustrated in FIG. 10 includes sound emitter 11, sound receiver 12, controller 15, communication unit 16, and detector 40. Sound emitter 11, sound receiver 12, and communication unit 16 are equivalent to those described in Embodiment 1.

Detector 40 detects a person based on the reflected wave signal outputted from receiver 12. Detector 40 generates an image indicating a direction of arrival of reflected waves, by performing beamforming on the reflected wave signal obtained via the plurality of microphones 12a.

Detector 40 obtains information regarding the position and size of a person present in indoor space S, from the intensity distribution of the reflected waves shown in the image. For example, when the image includes an area having an intensity value that is greater than or equal to a predetermined value, detector 40 determines that the area corresponds to a person and thus detects the person. More specifically, detector 40 of detection device 10A detects the position and size of a person present in indoor space S, based on a high-intensity image area having an intensity value that is greater than or equal to the predetermined value. Detector 40 outputs the obtained detection result to controller 15.

Controller 15 is a processor that controls sound emitter 11, sound receiver 12, communication unit 16, and detector 40. Controller 15 outputs information regarding the detection result obtained by detector 40, to information processing device 20A via communication unit 16.

Information processing device 20A illustrated in FIG. 10 includes data processing unit 30A, display 70, communication unit 80, and storage 90. Display 70, communication unit 80, and storage 90 are equivalent to those described in Embodiment 1.

Data processing unit 30A includes determiner 50 and controller 60. Determiner 50 and controller 60 are equivalent to those described in Embodiment 1.

Determiner 50 determines whether the detected person is a person not permitted to operate predetermined device 9, based on information transmitted from detection device 10A. Controller 60 controls predetermined device 9 provided in indoor space S, based on the determination result obtained by determiner 50.

Information processing device 20A according to Embodiment 2 is capable of controlling predetermined device 9 based on the detected person. To be more specific, by determining whether the person detected using the sound is a person not permitted to operate predetermined device 9, a person who should not be permitted to operate device 9, such as a child, is restricted from operating device 9.

### Embodiment 3

Information processing system 1B according to Embodiment 3 is described. In Embodiment 3, an example is described in which information processing device 20B has the functions of detection device 10 described in Embodiment 1.

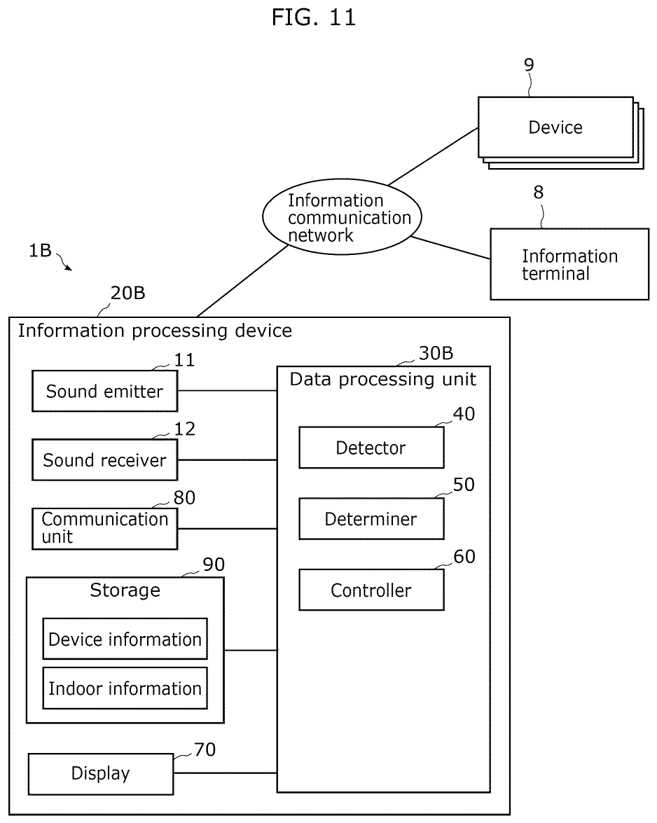

FIG. 11 is a block diagram illustrating the functional configuration of information processing system 1B according to Embodiment 3. Note that FIG. 11 also shows a plurality of devices 9 and information terminal 8.

As illustrated in FIG. 11, information processing system 1B includes information processing device 20B.

Information processing device 20B is mounted on a wall of indoor space S, for example.

Information processing device 20B includes sound emitter 11, sound receiver 12, communication unit 80, data processing unit 30B, storage 90, and display 70. Information processing device 20B causes sound emitter 11 to transmit a transmission sound and causes sound receiver 12 to obtain a reflected sound.

Data processing unit 30B includes detector 40, determiner 50, and controller 60. Detector 40 of data processing unit 30B obtains the reflected wave signal outputted from sound receiver 12 and performs data processing equivalent to that described in Embodiment 1.

Information processing device 20B according to Embodiment 3 is capable of controlling predetermined device 9 based on the detected person. To be more specific, by determining whether the person detected using the sound is a person not permitted to operate predetermined device 9, a person who should not be permitted to operate device 9, such as a child, is restricted from operating device 9.

### Embodiment 4

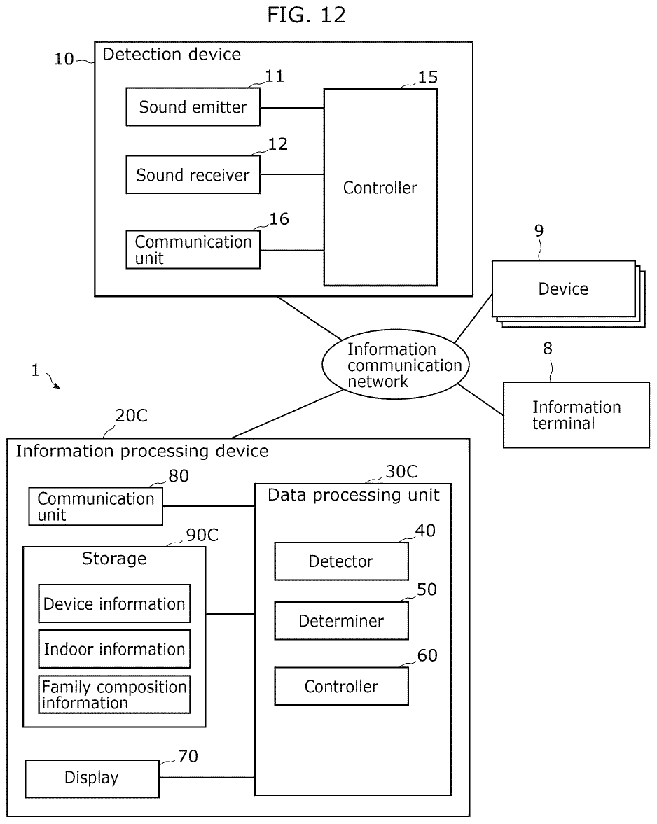

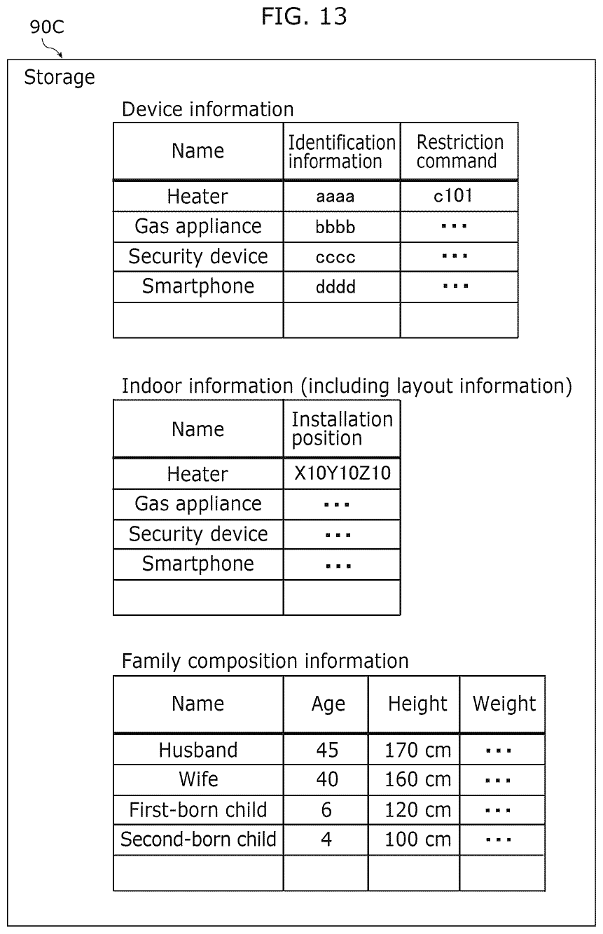

Information processing system 1C according to Embodiment 4 is described with reference to FIGS. 12 and 13. In Embodiment 4, an example is described in which whether the detected person is a person not permitted to operate a predetermined device is determined based on information regarding a family composition.

FIG. 12 is a block diagram illustrating the functional configuration of information processing system 1C according to Embodiment 4. Note that FIG. 12 also shows a plurality of devices 9 provided in indoor space S and information terminal 8 carried by a user inside or outside indoor space S.

As illustrated in FIG. 12, information processing system 1C includes detection device 10 and information processing device 20C. Detection device 10, information terminal 8, and the plurality of devices 9 are equivalent to those described in Embodiment 1.

Information processing device 20C illustrated in FIG. 12 includes data processing unit 30C, display 70, communication unit 80, and storage 90C. Display 70 and communication unit 80 are equivalent to those described in Embodiment 1.

Storage 90C stores: device information outputted from the plurality of devices 9; and indoor information and family composition information outputted from information terminal 8.

FIG. 13 is a diagram illustrating the device information, the indoor information, and the family composition information that are stored in storage 90C of information processing device 20C. The device information and the indoor information are equivalent to those described in Embodiment 1.

The family composition information stored in storage 90C is information regarding, for example, a family that uses indoor space S. The family composition information includes information indicating whether a family member is an adult or a child, for example, a husband, wife, first-born child, or second-born child. The family composition information may also include information regarding the age, height, and weight of the family member. Such family composition information is inputted by the user to information terminal 8 in association with the device information. Then, the family composition information is transmitted from information terminal 8 to information processing device 20C via the information communication network, and stored into storage 90C.

Data processing unit 30C illustrated in FIG. 12 includes detector 40, determiner 50, and controller 60. Detector 40 and controller 60 are equivalent to those described in Embodiment 1.

Determiner 50 determines whether the detected person is a person not permitted to operate predetermined device 9, based on the detection result obtained by detector 40 and the family composition information. For example, when the detected person is a child, determiner 50 determines that the detected person is a person not permitted to operate predetermined device 9. When the detected person is not a child, determiner 50 determines that the detected person is a person permitted to operate predetermined device 9.

Determiner 50 derives the height of the person, based on the information obtained by detector 40. When the derived height of the person does not exceed the average height of lower-grade elementary school students (i.e., 7-year-olds) and the family composition information indicates the presence of such a family member, determiner 50 may identify the detected person as a child.

The result of the determination performed by determiner 50, or more specifically, the determination result indicating whether the detected person is a person not permitted to operate predetermined device 9 is outputted to controller 60.

Controller 60 controls predetermined device 9 provided in indoor space S, based on the determination result obtained by determiner 50.

As described above, information processing device 20C according to the present embodiment includes: determiner 50 that determines whether the person detected using the reflected sound resulting from the transmission sound is a person not permitted to operate predetermined device 9; and controller 60 that controls the predetermined device based on a result obtained by determiner 50. Information processing device 20C described above is capable of controlling predetermined device 9 based on the person detected using a sound. To be more specific, by determining whether the person detected using the sound is a person not permitted to operate predetermined device 9, a person who should not be permitted to operate device 9, such as a child, is restricted from operating device 9.

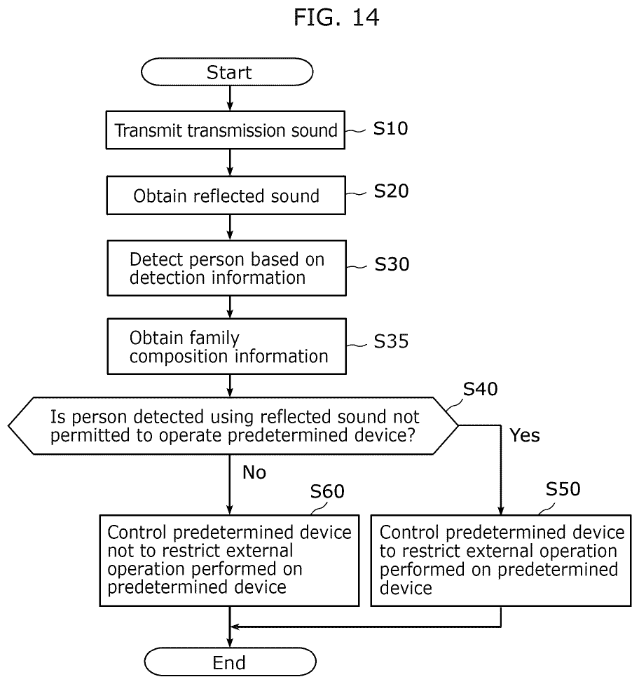

The information processing method according to Embodiment 4 is described with reference to FIG. 14.

FIG. 14 is a flowchart illustrating the information processing method according to Embodiment 4.

In this information processing method, detection device 10 first transmits a transmission sound toward indoor space S (step S10). Furthermore, detection device 10 obtains a sound reflected from a person as a result of the transmission of the ultrasonic wave (step S20). Detection device 10 outputs the obtained detection information to information processing device 20C.

Information processing device 20C detects the person, based on the detection information outputted from detection device 10 (step S30). For example, information processing device 20C generates, based on the reflected sound, an image indicating a direction of arrival of the reflected waves. To be more specific, information processing device 20C generates the image indicating the direction of arrival of the reflected waves by performing beamforming on the reflected wave signal obtained via the plurality of microphones 12a. Then, information processing device 20C obtains information regarding the position and size of the person present in indoor space S, from the intensity distribution of the reflected waves shown in the generated image.

Next, information processing device 20C obtains the family composition information (step S35). The family composition information has been stored in storage 90C in advance. Thus, information processing device 20C obtains the family composition information from storage 90C.

Next, information processing device 20C determines whether the person detected using the reflected sound is a person not permitted to operate predetermined device 9 (step S40).

Information processing device 20C determines whether the detected person is a child, based on the information regarding the size of the person that is obtained in step S30 and the family composition information obtained in step S35. Note that determining whether the person is a child is substantially equivalent to determining whether the person is an adult. When the detected person is a child, the detected person is determined to be a person not permitted to operate predetermined device 9. When the detected person is not a child, the detected person is determined to be a person permitted to operate predetermined device 9.

Information processing device 20C controls predetermined device 9, based on the result of the determination performed in step S40. Note that predetermined device 9 is an electrical device provided in indoor space S in which the person detected using the reflected sound is present. Information regarding predetermined device 9 has been stored in storage 90C in advance.

When the person detected using the reflected sound is the aforementioned not-permitted person (Yes in S40), information processing device 20C controls predetermined device 9 to restrict an external operation performed on predetermined device 9 (step S50). In contrast, when the person detected using the reflected sound is the aforementioned permitted person (No in S40), information processing device 20C controls predetermined device 9 not to restrict an external operation performed on predetermined device 9 (step S60).

The information processing method described above enables predetermined device 9 to be controlled based on a person detected using a sound. More specifically, when the person detected using the sound is determined to be a person who should not be permitted to operate device 9, such as a child, operation of device 9 is restricted.

### Other Embodiments

Although the information processing method and the like according to the embodiments of the present disclosure are described above, the present disclosure is not limited to the embodiments. One or more aspects of the present disclosure may include one or more embodiments achieved by making various changes envisioned by those skilled in the art to the above embodiments and one or more embodiments achieved by combining structural elements included in different embodiments, as long as such embodiments do not depart from the spirit of the present disclosure.

In Embodiment 1, detector 40 detects a person based on the two-dimensional image generated from the reflected waves, for example. However, this is not intended to be limiting. Detector 40 may obtain data of the time difference between the direct wave and the reflected wave. Then, detector 40 may detect a person, based on information indicating not only the direction of arrival of the reflected sound but also the depth direction (the direction orthogonal to both the vertical and horizontal directions) of the reflected sound. In Embodiment 1, detector 40 detects a person based on the two-dimensional still image, for example. However, this is not intended to be limiting. Detector 40 may detect a person based on a moving image generated by sequentially combining two-dimensional still images. Moreover, determiner 50 may determine whether the detected person is a child, based on the moving image.

In Embodiment 1, detector 40 and determiner 50 of information processing device 20 are separate structural elements, for example. However, the respective functions of detector 40 and determiner 50 may be implemented by a single structural element.

In Embodiment 1, sound emitter 11 and sound receiver 12 are separate structural elements, for example. However, this is not intended to be limiting. Sound emitter 11 and sound receiver 12 may be combined into a single ultrasonic sensor.

In Embodiment 1, information processing device 20 is hardware, for example. However, this is not intended to be limiting. The functions of the information processing device may be implemented through cloud computing.

Furthermore, in Embodiments 1 and 2, each structural element may be implemented by executing a software program suitable for the structural element. Each structural element may be implemented by a program executer, such as a CPU or a processor, reading and executing a software program stored in a recording medium, such as a hard disk or semiconductor memory.

Furthermore, each structural element may be embodied as hardware. Each structural element may be a circuit (or an integrated circuit). Together, these circuits may form one circuit, or these circuit may be separate circuits. Furthermore, these circuits may be general-purpose circuits or dedicated circuits.

It should be noted that a general or specific aspect of the present disclosure is embodied as a system, a device, a method, an integrated circuit, a computer program, or a computer-readable recording medium, such as a CD-ROM. A general or specific aspect of the present disclosure may be embodied as any combination of the system, device, method, integrated circuit, computer program, and recording medium.

For instance, the present disclosure may be embodied as the data processor in the above embodiments and as the information processing system in the above embodiments. Furthermore, the present disclosure may be embodied as an information processing method performed by a computer such as the information processing system in the above embodiments. The present disclosure may be embodied as a program for causing a computer to execute the information processing method or a computer-readable, non-transitory recording medium on which the program is recorded.

### INDUSTRIAL APPLICABILITY

The information processing method and the like according to the present disclosure are widely applicable as a device control method for controlling a device provided in a facility.

1. An information processing method that is executed by a computer, the information processing method comprising:
transmitting a sound;
obtaining a reflected sound resulting from the sound;
determining whether a person detected using the reflected sound is a person not permitted to operate a predetermined device; and
controlling the predetermined device based on a result obtained in the determining.

2. The information processing method according to claim 1,
wherein in the controlling,
when the person detected using the reflected sound is determined to be the person not permitted to operate the predetermined device, the predetermined device is controlled to restrict an external operation performed on the predetermined device.

3. The information processing method according to claim 1,
wherein in the controlling,
when the person detected using the reflected sound is determined to be a person permitted to operate the predetermined device, the predetermined device is controlled not to restrict an external operation performed on the predetermined device.

4. The information processing method according to claim 1,
wherein the predetermined device is an electrical device provided in a space in which the person detected using the reflected sound is present.

5. The information processing method according to claim 1,
wherein in the determining,
the person is detected based on an image indicating a direction of arrival of a reflected wave resulting from the reflected sound.

6. The information processing method according to claim 5,
wherein the determining is performed based on a corrected-normalized value, the corrected-normalized value is calculated by correcting and normalizing, using a distance, one of: a size of an area corresponding to the person detected, in the image; or an aspect ratio of the area corresponding to the person detected,
when the corrected-normalized value is less than or equal to a predetermined value, the person detected is determined to be the person not permitted to operate the predetermined device, and
when the corrected-normalized value exceeds the predetermined value, the person detected is determined to be a person permitted to operate the predetermined device.

7. The information processing method according to claim 1, wherein
the sound is an ultrasonic wave.

8. The information processing method according to claim 1, further comprising:
when a plurality of persons are detected using the reflected sound and the plurality of persons include both the person not permitted and a person permitted to operate the predetermined device,
obtaining, based on the reflected sound, both a position of the person not permitted and a position of the person permitted; and
controlling the predetermined device based on a first distance between the person not permitted and the person permitted.

9. The information processing method according to claim 8,
wherein in the controlling,
when the first distance is greater than or equal to a first threshold value, the predetermined device is controlled to restrict an external operation performed on the predetermined device, and
when the first distance is less than the first threshold value, the predetermined device is controlled without the restriction of the external operation performed on the predetermined device.

10. The information processing method according to claim 1, further comprising:
obtaining a position of the person detected, based on the reflected sound;
obtaining position information of the predetermined device; and
controlling the predetermined device based on a second distance between the person detected and the predetermined device.

11. The information processing method according to claim 10,
wherein in the controlling,
when the second distance is less than a second threshold value, the predetermined device is controlled to restrict an external operation performed on the predetermined device, and
when the second distance is greater than or equal to the second threshold value, the predetermined device is controlled without the restriction of the external operation performed on the predetermined device.

12. The information processing method according to claim 1, further comprising:
obtaining registration information when information indicating that the predetermined device has received an external operation input is received as a trigger, the registration information indicating whether the predetermined device that has received the external operation input is a registered device that has been registered in advance to restrict an external operation; and
controlling, based on the registration information, the predetermined device that has received the external operation input.

13. The information processing method according to claim 12,
wherein in the controlling,
when the predetermined device that has received the external operation input is the registered device and the person detected using the reflected sound is determined to be the person not permitted to operate the predetermined device, the predetermined device is controlled to be prevented from operating in response to the external operation input.

14. An information processing system comprising:
a sound emitter that transmits a sound;
a sound receiver that obtains a reflected sound resulting from the sound;
a determiner that determines whether a person detected using the reflected sound is a person not permitted to operate a predetermined device; and
a controller that controls the predetermined device based on a result obtained by the determiner.

15. An information processing device comprising:
a determiner that determines whether a person detected using a reflected sound resulting from a transmitted sound is a person not permitted to operate a predetermined device; and
a controller that controls the predetermined device based on a result obtained by the determiner.

16. A non-transitory computer-readable recording medium having recorded thereon a program for causing a computer to execute the Information processing method according to claim 1.
